(19) United States
(12) Patent Application Publication
(10) Pub. No.: US 2003/0212618 A1
(43) Pub. Date: Nov. 13, 2003

(54) Systems and methods associated with targeted leading indicators

(75) Inventors: Jennifer M. Keyes, West Redding, CT (US); Charles J. Litty, Southbury, CT (US)

Correspondence Address: BUCKLEY, MASCHOFF, TALWALKAR, & ALLISON, 5 ELM STREET, NEW CANAAN, CT, 06840, US

(73) Assignee: General Electric Capital Corporation, Stamford, CT

(21) Appl. No.: 10/063,663

(22) Filed: May 7, 2002

(51) Int. Cl. G06F 17/60

(52) U.S. Cl. 705/35; 705/38

(57) ABSTRACT

Systems and methods associated with targeted leading indicators are provided. According to one embodiment, at least one condition associated with a target business segment is determined. A series of indicator input items is selected, and a forecast model for the target business segment is automatically generated based on historic information associated with the series of indicator input items and the condition.

### CROSS REFERENCE TO RELATED APPLICATIONS

Referenced-Applications

The present application is related to U.S. patent application Ser. No. 10/026,104 entitled “Systems and Methods to Facilitate Analysis of Commercial Credit Customers” and filed on Dec. 21, 2001. The entire contents of that application are incorporated herein by reference.

### BACKGROUND OF INVENTION

1. Field

The present invention relates to indicators. In particular, some embodiments of the present invention are associated with the use of a forecast model to predict future conditions for a target business segment based on a series of indicator input items.

2. Background

A creditor may extend credit to customers via credit accounts. For example, a commercial credit account might be used to finance a customer's purchase of commercial equipment, such as trucks, machine tools, or telecommunication equipment. In this case, the equipment being purchased is typically used as collateral to secure the credit being extended to the customer. As another example, a commercial credit account might be used when a customer leases commercial equipment.

Of course, there is always some risk that a customer will fail to provide payments associated with a commercial credit account. For example, a customer may become bankrupt or simply lack sufficient funds to provide payments in a timely manner. In this case, the creditor can suffer a loss associated with some, or even all, of the credit that had been extended to the customer. This risk can be especially serious with respect to commercial accounts because of the significant amount of credit that is often extended via such accounts.

If a creditor could identify those customers who are more likely to have such problems (i.e., “high risk” customers), the commercial credit accounts associated with those customers could be closely monitored. For example, the creditor might quickly contact a high risk customer when a delayed payment is detected. Moreover, the creditor might be able to re-schedule or otherwise adjust payments to reduce the risk of suffering a loss because of a high risk customer. Note that it may be impractical for a creditor to quickly contact and/or negotiate with each and every customer who delays a payment (e.g., the creditor may be extending credit to hundreds or thousands of customers). Similarly, a creditor may be interested in identifying portfolios of high risk commercial credit accounts (e.g., to limit the amount of credit that will be extended to similar accounts in the future).

It is known that a risk manager associated with a creditor can manually review commercial credit accounts in an attempt to identify high risk accounts or customers. Such an approach, however, can be subjective and may be inefficient when there are a large number of customers involved. Moreover, the risk manager's task may be further complicated if each customer has a number of separate commercial credit accounts.

It is also known that a statistical model can be applied to in an attempt to identify high risk customers or accounts. For example, all accounts that had payment delays of more than thirty days during the last year might be identified as high risk accounts. Applying a single model to all commercial credit accounts, however, may improperly identity some accounts as high risk while failing to identify other accounts that are, in fact, high risk. For example, it might not be uncommon for commercial credit accounts associated with a certain type of collateral to delay payments by more than thirty days. As a result, it would be inefficient to identify such an account as high risk simply because a customer had delayed payment by forty days.

It is further known that leading indicators can be used to predict overall business cycles, and thus, indirectly, to predict the general performance of commercial credit accounts and portfolios as a whole. For example, the Conference Board Economics Program generates an Index of Leading Economic Indicators (LEI) that can be used to predict business cycles. Such indicators, however, are generated with respect to the entire United States economy (or even the global economy) and therefore may not accurately predict the performance of commercial credit accounts or portfolios within a particular business segment (e.g., within the automotive industry).

### SUMMARY OF INVENTION

To alleviate problems inherent in the prior art, the present invention introduces systems and methods associated with targeted leading indicators.

According to one embodiment, at least one condition associated with a target business segment is determined. A series of indicator input items is selected, and a forecast model for the target business segment is automatically generated based on historic information associated with the series of indicator input items and the condition.

According to another embodiment, a forecast model for a target business segment associated with an existing credit account is retrieved, and a series of indicator input values is determined. A future condition is then predicted based on the forecast model and the series of indicator input values. A score associated with the credit account may then be adjusted based on the prediction. According to yet another embodiment, a potential credit deal is adjusted based on a prediction associated with deal's target business segment.

According to another embodiment, at least one condition associated with a target business segment is determined, and a series of indicator input items is selected. A forecast model for the target business segment is then generated. Future conditions are predicted based on current indicator input items and the forecast model, and a score associated with an existing credit account is adjusted based on the prediction. According to still another embodiment, a potential credit deal is adjusted based on the prediction.

One embodiment of the present invention comprises: means for determining at least one condition associated with a target business segment; means for selecting a series of indicator input items; and means for automatically generating a forecast model for the target business segment based on historic information associated with the series of indicator input items and the condition.

Another embodiment comprises: means for retrieving a forecast model for a target business segment associated with an existing credit account; means for determining a series of indicator input values; means for predicting a future condition based on the forecast model and the series of indicator input values; and means for adjusting a score associated with the credit account based on said prediction.

Still another embodiment comprises: means for retrieving a forecast model for a target business segment associated with a potential credit deal; means for determining a series of indicator input values; means for predicting a future condition based on the forecast model and the series of indicator input values; and means for adjusting the potential credit deal based on said prediction.

A technical effect of some embodiments of the present invention is to provide a computer adapted to efficiently facilitate the generation and/or use of targeted leading indicator information.

With these and other advantages and features of the invention that will become hereinafter apparent, the invention may be more clearly understood by reference to the following detailed description of the invention, the appended claims, and the drawings attached herein.

### BRIEF DESCRIPTION OF DRAWINGS

FIG. 1 is a flow chart of a method according to some embodiments of the present invention.

FIG. 2 is a block diagram overview of a leading indicator system according to embodiments of the present invention.

FIG. 3 is a tabular representation of a portion of a customer database according to an embodiment of the present invention.

FIG. 4 is a tabular representation of a portion of an account database according to an embodiment of the present invention.

FIG. 5 is a tabular representation of a portion of a indicator input database according to an embodiment of the present invention.

FIG. 6 is a tabular representation of a portion of a condition database according to an embodiment of the present invention.

FIG. 7 is a tabular representation of a portion of a forecast model database according to an embodiment of the present invention.

FIG. 8 is a tabular representation of a portion of a risk information database according to an embodiment of the present invention.

FIG. 9 is a flow chart of a method of facilitating use of targeted indicators according to some embodiments of the present invention.

FIG. 10 illustrates performance bins according to some embodiments of the present invention.

FIG. 11 is a flow chart of a method of facilitating use of targeted indicators according to other embodiments of the present invention.

FIG. 12 is a block diagram of a credit account system according to some embodiments of the present invention.

FIG. 13 illustrates a watch list display according to an embodiment of the present invention.

FIG. 14 is a block diagram including elements of a watch list controller according to some embodiments of the present invention.

FIG. 15 is a flow chart of a method of facilitating use of targeted indicators according to other embodiments of the present invention.

### DETAILED DESCRIPTION

Embodiments of the present invention are directed to systems and methods associated with “indicators.” As used herein, the term “indicator” may refer to any information associated with economic or financial performance. For example, a leading indicator is associated with future economic or financial performance (e.g., performance three months in the future). As other examples, lagging and coincident indicators are associated with past and current performance, respectively.

In addition, the phrase “commercial credit account” may refer to any account that is used to extend credit to a commercial customer. For example, credit may be extended to a business in connection with a commercial equipment purchase or lease (e.g., for trucks, trailers, forklifts, machine tools, or telecommunication equipment).

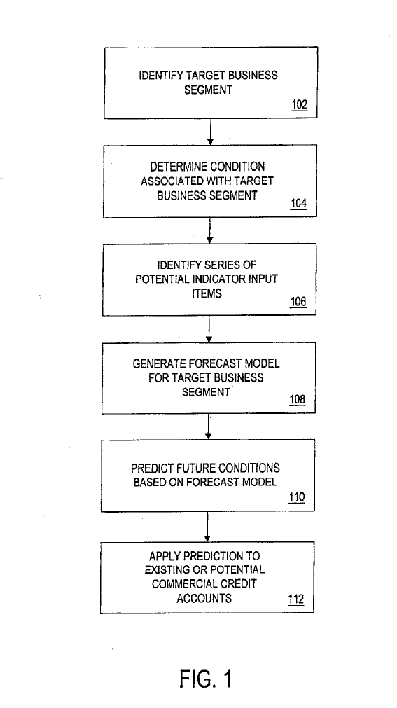

Turning now to the drawings, FIG. 1 is a flow chart of a method according to some embodiments of the present invention. The flow charts in FIG. 1 and the other figures described herein do not imply a fixed order to the steps, and embodiments of the present invention can be practiced in any order that is practicable.

At 102, a target business segment is identified. The target business segment may be associated with, for example, an industry or an industry segment (e.g., manufacturing, construction, retail trade, services, and/or wholesale trade). Other examples may include agriculture, forestry, fishing, mining, transportation, communication, utility (e.g., electric gas, or sanitary services), finance, insurance, real estate, and public administration. Similarly, the target business segment may be associated with a market or market segment. According to some embodiments, the target business segment may be associated with a customer (e.g., a large customer) or group of customers. The target business segment might further be associated with a collateral type, a geographic location, and/or a customer type (e.g., the target business segment may be associated with small retail stores in the western United States).

At 104, at least one condition associated with the target business segment is identified. The condition may comprise, for example, an economic condition associated with the performance of the target business segment (e.g., indicating whether the segment is expanding or contracting). The condition may also be associated with, for example, payment information (e.g., a loan default rate within the target business segment), a business cycle, and/or other industry behaviors.

A series of potential indicator input items is identified at 106. That is, a number of items that might potentially be used by a forecast model for the target business segment may be identified. The potential indicator input items may be associated with any type of economic information, such as employment information, inflation information, equity information (e.g., stock prices), debt information (e.g., bond prices), construction information, backlog information, new order information, vacancy information, interest rate information, and/or money supply information. Other examples of potential indicator input items include payment and delinquency information (e.g., associated with existing loans). Note that the potential indicator input items could be associated with a particular industry or market (or segment).

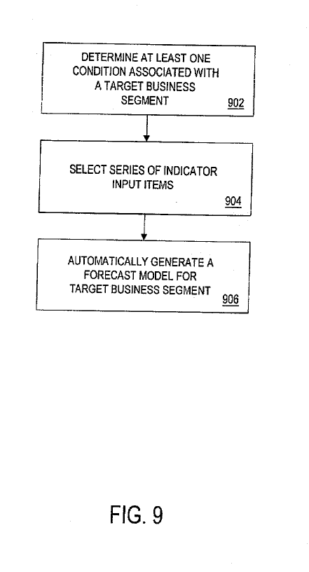

At 108, a forecast model for the target business segment is generated based on historic information associated with (i) the series of indicator input items and (ii) the condition. For example, the potential indicator input items may be evaluated to select a final series of indicator input items. Actual historic values for these indicator input items may then be retrieved. Historic values for the condition associated with the target business segment are also retrieved. Note that some or all of these values may be seasonally adjusted, translated into rolling median information, standardized, and/or adjusted via correlation coefficients. The evaluation may also be associated with weighted averages and/or a graphical analysis. Also note that the forecast model may be associated with one or more leading indicators, lagging indicators, and/or coincident indicators. Some methods of generating a forecast model are described with respect to FIG. 9.

At 110, future conditions are predicted for the target business segment based on current indicator input items and the forecast model. The prediction may then be applied to an existing commercial credit account, customer, or portfolio at 112. For example, a customer who would otherwise be assigned a high risk score (e.g., based on his or her past behavior) may be assigned a lower score if a forecast model predicts positive changes in the customer's business segment. Of course, if the forecast model instead predicts negative changes the customer may be assigned a higher score. According to another embodiment, the prediction is applied to a potential credit account (e.g., a potential commercial credit deal). According to still another embodiment, the prediction is applied to a long term time series model, such as a model that predicts how many trailers will be sold one year from now.

Leading Indicator System

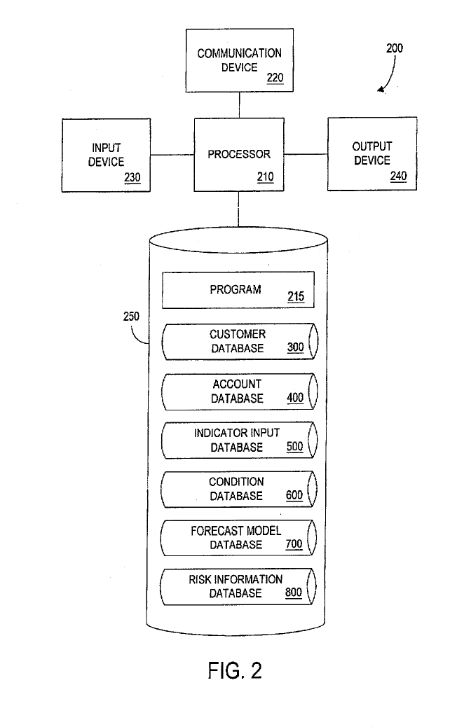

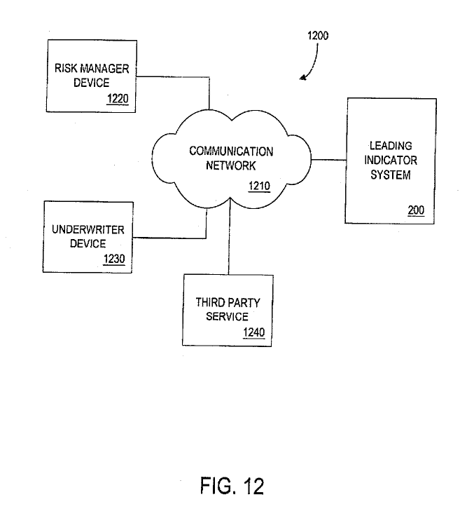

FIG. 2 is a block diagram overview of a leading indicator system 200 according to some embodiments of the present invention. The controller 200 includes a processor 210, such as one or more INTEL® Pentium® processors. The processor 210 is coupled to a communication device 220 that may be used, for example, to exchange information with other devices (e.g., a devices described with respect to FIG. 12).

The processor 210 is in communication with an input device 230. The input device 230 may comprise, for example, a keyboard, a mouse or other pointing device, a microphone, and/or a touch screen. Such an input device 230 may be used, for example, by an operator to enter or select a series of indicator input values or conditions.

The processor 210 is also in communication with an output device 240. The output device 240 may comprise, for example, a display (e.g., a computer monitor), a speaker, and/or a printer. The output device 240 may be used, for example, to provide a prediction or a risk score to an operator.

The processor 210 is also in communication with a storage device 250. The storage device 250 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 250 stores one or more programs 215 for controlling the processor 210. The processor 210 performs instructions of the programs 215, and thereby operates in accordance with the present invention. For example, the processor 210 may determine at least one condition associated with a target business segment and select a series of indicator input items. The processor 210 may also automatically generate a forecast model for the target business segment based on historic information associated with (i) the series of indicator input items and (ii) the condition.

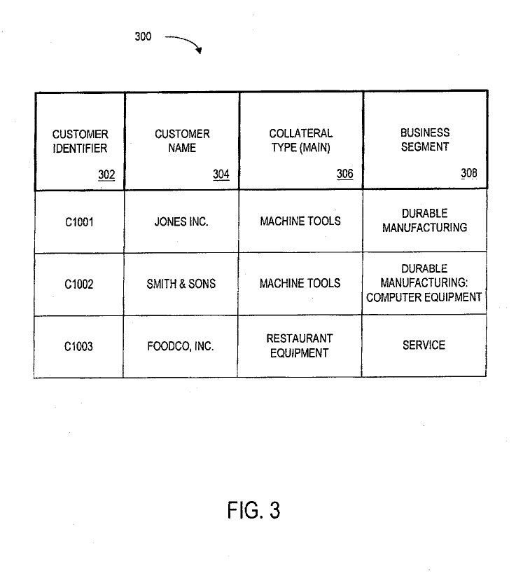

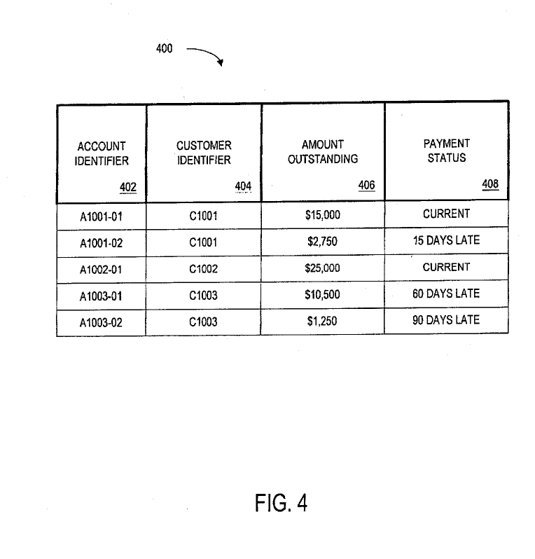

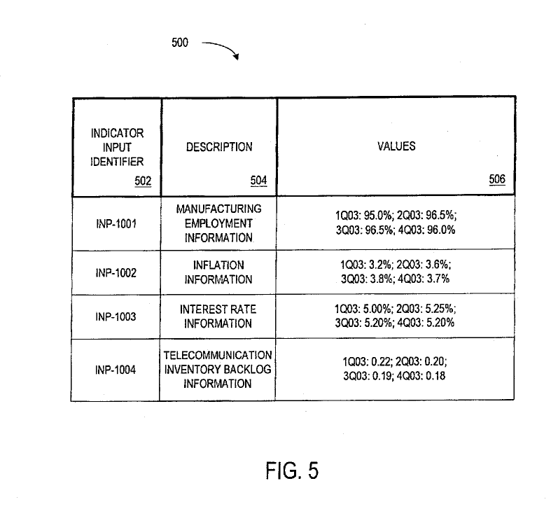

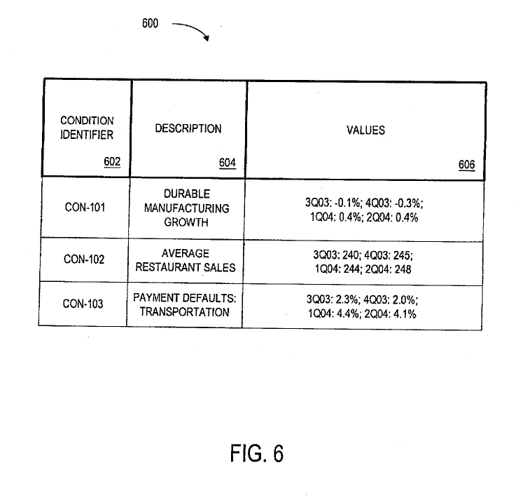

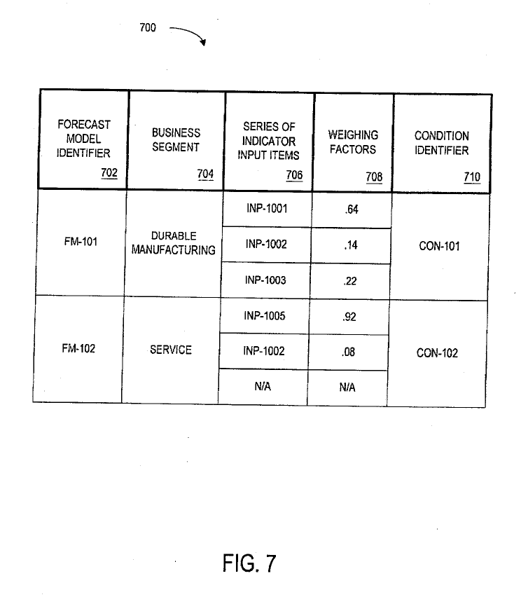

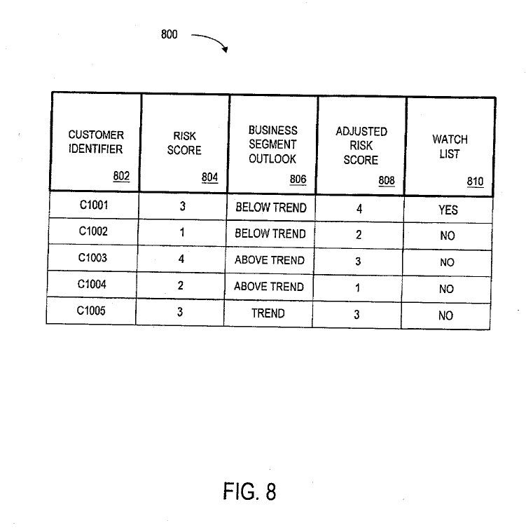

As shown in FIG. 2, the storage device 250 also stores a customer database 300 (described with respect to FIG. 3), an account database 400 (described with respect to FIG. 4), an indicator input database 500 (described with respect to FIG. 5), a condition database 600 (described with respect to FIG. 6), a forecast model database 700 (described with respect to FIG. 7), and a risk information database 800 (described with respect to FIG. 8). Examples of databases that may be used in connection with controller 200 will now be described in detail with respect to FIGS. 3 through 8. The illustrations and accompanying descriptions of the databases presented herein are exemplary, and any number of other database arrangements could be employed besides those suggested by the figures.

Customer Database

Referring to FIG. 3, a table represents the customer database 300 that may be stored at the leading indicator system 200 according to an embodiment of the present invention. The table includes entries identifying customers who have (or may) receive credit via one or more commercial credit accounts. The table also defines fields 302, 304, 306, 308 for each of the entries. The fields specify: a customer identifier 302, a customer name 304, a collateral type 306, and a business segment 308. The information in the customer database 300 may be created and updated, for example, based on information received from a customer or a risk manager.

The customer identifier 302 may be, for example, an alphanumeric code associated with a customer who received (or may receive) credit via one or more commercial credit accounts. The customer name 304 identifies the customer, and the collateral type 306 indicates the type of collateral that is being (or may be) used to secure credit for that customer.

The business segment 308 is associated with the customer's main business. For example, the business segment 308 might be based on a two or three digit Standard Industrial Classification (SIC) identifier.

Other information may also be stored in the customer database 300. For example, a geographic region might indicate the customer's main place of business. The geographic region could be used, for example, to generate a risk score or to aggregate risk information on a portfolio basis (e.g., to determine the amount of risk associated with all “north east” commercial credit customers).

Account Database

Referring to FIG. 4, a table represents the account database 400 that may be stored at the leading indicator system 200 according to an embodiment of the present invention. The table includes entries identifying commercial credit accounts being used to extend credit to customers. The table also defines fields 402, 404, 406, 408 for each of the entries. The fields specify: an account identifier 402, a customer identifier 404, an amount outstanding 406, and a payment status 408. The information in the account database 400 may be created and updated, for example, based on information received from a risk manager.

The account identifier 402 may be, for example, an alphanumeric code associated with a commercial credit account being used to extend credit to a customer The customer identifier 404 may be, for example, an alphanumeric code associated with the customer who is receiving credit and may be based on, or associated with, the customer identifier 302 stored in the customer database 300.

The amount outstanding 406 represents an amount currently owed by the customer with respect to the commercial credit account, and the payment status 408 indicates whether the customer's payment are presently “current” or “late.” The information in the account database 400 may be used, for example, to generate a risk score for a customer, an account, and/or a portfolio.

Other information may also be stored in the account database 400. For example, a collateral type or a product type may be associated with a particular account.

Indicator Input Database

Referring to FIG. 5, a table represents the indicator input database 500 that may be stored at the leading indicator system 200 according to an embodiment of the present invention. The table includes entries identifying input items that a forecast model may use to generate predictions. The table also defines fields 502, 504, 506 for each of the entries. The fields specify: an indicator input identifier 502, a description 504, and one or more values 506. The information in the indicator input database 500 may be generated and/or updated, for example, by an economic information service. The indicator input identifier 502 may be, for example, an alphanumeric code associated with a particular input item that may be used to generate predictions and the description 504 describes the item.

The values 506 indicate historic (i.e., past) values associated with the item. For example, as shown by the fourth entry in FIG. 5, prior telecommunication inventory backlog values 506 are stored on a quarterly basis. Note that the indicator input database 500 may also store current values 506.

Also note that “historic” values might be adjusted or revised (e.g., by an economic information service). For example, a preliminary consumer confidence index may be reported as “85” and adjusted to “90” three months later.

Condition Database

Referring to FIG. 6, a table represents the condition database 600 that may be stored at the leading indicator system 200 according to an embodiment of the present invention. The table includes entries identifying conditions that may be associated with one or more target business segments. The table also defines fields 602, 604, 606 for each of the entries. The fields specify: a condition identifier 602, a description 604, and one or more values 506. The information in the condition database 600 may be generated and/or updated, for example, by an economic information service.

The condition identifier 602 may be, for example, an alphanumeric code for a particular condition associated with one or more target business segments and the description 604 describes the condition. The values 606 indicate historic (i.e., past) values associated with the condition. For example, as shown by the second entry in FIG. 6, prior average restaurant sales values 606 are stored on a quarterly basis. Note that the condition database 600 may also store current or predicted values 606. As before, the “historic” values might be adjusted or revised (e.g., by an economic information service).

Forecast Model Database

Referring to FIG. 7, a table represents the forecast model database 700 that may be stored at the leading indicator system 200 according to an embodiment of the present invention. The table includes entries identifying forecast models that may be used to predict future conditions for a target business segment. The table also defines fields 702, 704, 706, 708, 710 for each of the entries. The fields specify: a forecast model identifier 702, a business segment 704, a series of indicator input items 706 and associated weighing factors 708, and a condition identifier 710.

The forecast model identifier 702 may be, for example, an alphanumeric code associated with a particular forecast model that may be used to predict conditions for the target business segment 704. Note that the business segment 704 may be based on, or associated with, the business segment 308 stored in the customer database 300.

The series of indicator input items 706 define which values will be used by the forecast model to make predictions (and may be based on, or associated with the indicator input identifiers 502 stored in the indicator input database 500). The condition identifier 710 defines the future values will be predicted by the forecast model (and may be based on, or associated with the condition identifiers 602 stored in the condition database 600).

The weighing factors 708 define how the forecast model will translate the series indicator input items 706 when predicting a future condition value. For example, the forecast model having a forecast model identifier 702 of “FM-101” will predict durable manufacturing growth (i.e., “CON-101”) using the following weighted values: manufacturing employment information×0.64; inflation information×0.14; and interest rate information×0.22. That is, manufacturing employment information will have the greatest effect on the predicted durable manufacturing growth—while inflation information will have the least. Of course, the forecast model database 700 may store other information, such as one or more formulas that actually translate indicator input values into a predicted outlook for the business segment.

Risk Information Database

Referring to FIG. 8, a table represents the risk information database 800 that may be stored at the leading indicator system 200 according to an embodiment of the present invention. The table includes entries that provide risk information for commercial credit account customers. The table also defines fields 802, 804, 806, 808, 810 for each of the entries. The fields specify: a customer identifier 802, a risk score 804, a business segment outlook 806, an adjusted risk score 808, and a watch list indication 810.

The customer identifier 802 may be, for example, an alphanumeric code associated with a customer receiving credit via one or more commercial credit accounts (and may be based on, or associated with, the customer identifier 302 stored in the customer database 300 and/or the customer identifier 404 stored in the account database 400).

The risk score 804 may represent, for example, a rating generated by a risk model in accordance with customer information (e.g., the collateral type 306 stored in the customer database 600, the amount outstanding 406 and payment status 408 stored in the account database 400, and/or a geographic region associated with the customer). The risk score illustrated in FIG. 8 ranges from 1 to 5 (with 5 representing the highest risk of loss to the creditor).

The business segment outlook 806 may represent, for example, a predicted value or category (i.e., a “bin”) generated by the appropriate forecast model (i.e., the forecast model associated with the customer's business segment). The business segment outlook 806 may indicate, for example, that the customer's business segment is expected to perform “below trend” (i.e., poorly), “trend” (i.e., average), or “above trend” (i.e., well).

The adjusted risk score 808 represents the customer's risk score 804 after it has been adjusted based on the business segment outlook 806. In the example of FIG. 8, outlooks of “below trend,” “trend,” and “above trend” result in score adjustments of −1, 0, and +1, respectively.

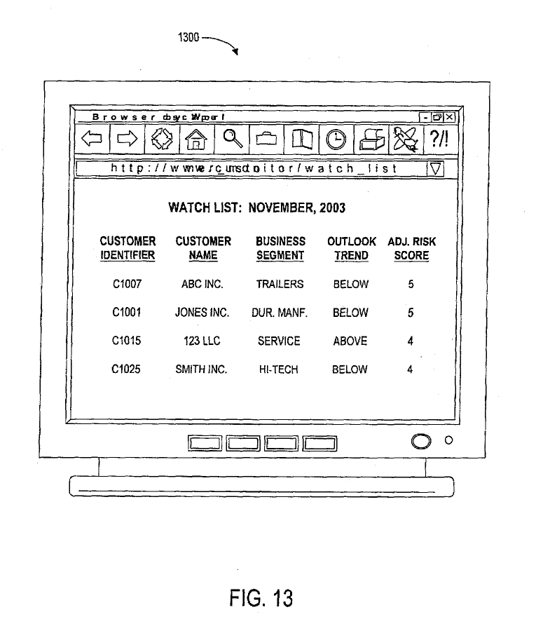

The watch list indication 810 represents whether or not the customer should be included on a list of high risk customers (e.g., such as the display 1300 illustrated in FIG. 13). In the example of FIG. 8, customers having a risk score of 4 or 5 are included in the watch list.

Forecast Model Generation

FIG. 9 is a flow chart of a method of facilitating use of targeted indicators according to some embodiments of the present invention. At 902, at least one condition associated with a target business segment is determined. For example, the leading indicator system 200 may select a condition for the target business segment from the condition database 600.

At 904, a series of indicator input items are selected. For example, the leading indictor system 200 may select an appropriate series of items from the indicator input database 500.

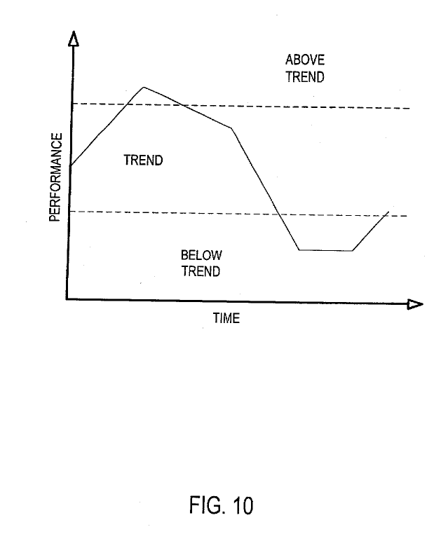

At 906, a forecast model for the target business segment is automatically generated based on historic information associated with: (i) the series of indicator input items and (ii) the condition. For example, the leading indicator system 200 may retrieve values 506, 606 from the indicator input database 500 and the condition database 600. Note that the condition values 606 may be associated with (e.g., translated into) one or more performance bins (e.g., “below trend,” “trend,” and “above trend”). FIG. 10 illustrates performance bins according to some embodiments of the present invention.

The automatic generation of the forecast model may be performed in accordance with, for example, a linear optimization technique. For example, the forecast model may be associated with weighing factors applied to each indicator input item. An example of a process that can perform such a weighted linear optimization is in the WHAT'S BEST!® 6.0 add-in for the MICROSOFT® EXCEL spreadsheet application. Other examples of optimization approaches include integer and non-linear techniques.

When the appropriate forecast model is generated, the series of indicator input items 706, associated weighting factors 708, and condition identifier 710 may be updated in the forecast model database 700.

Adjusting Customer Scores Based on Forecast Model Predictions

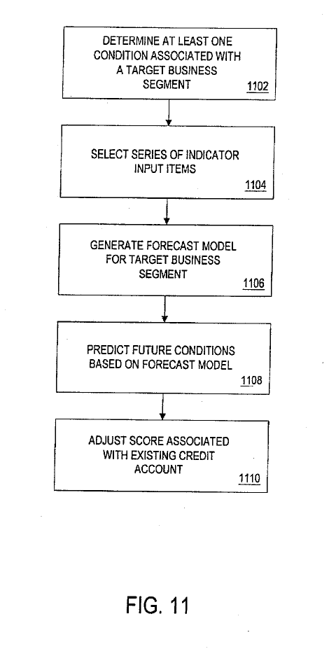

FIG. 11 is a flow chart of a method of facilitating use of targeted indicators according to other embodiments of the present invention. At 1102, at least one condition associated with a target business segment is determined. For example, the leading indicator system 200 may select a condition for the target business segment from the condition database 600 (e.g., based on information stored in the forecast model database 700).

At 1104, a series of indicator input items are selected. For example, the leading indictor system 200 may select an appropriate series of items from the indicator input database 500 (e.g., based on information stored in the forecast model database 700).

At 1106, a forecast model for the target business segment is generated (e.g., based on historic information associated with the series of indicator input items and the condition). According to another embodiment, a pre-existing forecast model is instead used (e.g., after being retrieved from the forecast model database 700). conditions are then predicted based on current indicator input values and the forecast model at 1108.

At 1110, a score associated with an existing credit account is adjusted based on the prediction. For example, a credit risk score might be increased if the client's business segment is contracting. According to some embodiments, the adjusted risk score is then provided to a risk manager. For example, FIG. 12 is a block diagram of a credit account system wherein the leading indicator system 200 can communicate with a risk manager device 1220 via a communication network 1210. The communication network 1210 may comprise, for example, a Local Area Network (LAN), a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet.

The leading indicator system 200 and the risk manager device 1220 may be any devices capable of performing the various functions described herein. The leading indicator system 200 may be associated with, for example, a Web server adapted to perform calculations, analyze information, and provide results in a periodic or substantially real-time fashion. The risk manager device 1220 may be, for example, a Personal Computer (PC) adapted to run a Web browser application (e.g., the INTERNET EXPLORER® application available from MICROSOFT®), a portable computing device such as a laptop computer or a Personal Digital Assistant (PDA), and/or a wireless device.

Note that the devices shown in FIG. 12 need not be in constant communication. For example, the leading indicator system 200 may communicate with the risk manager device 1220 on an as-needed or periodic basis. Moreover, although a single leading indicator system 200 and risk manager device 1220 are shown in FIG. 12, any number of these devices may be included in the credit account system 1200. Similarly, a single device may act as both a leading indicator system 200 and a risk manager device 1220. According to some embodiments, the leading indicator system 200 also exchanges information with a third-party service 1240, such as a service that provides business information reports or credit scores (e.g., EXPERIAN®, MOODYS-KMV®, or D&B, INC.®).

FIG. 13 illustrates a watch list display 1300 that may be provided via a risk manager device 1220 according to an embodiment of the present invention. In particular, the display 1300 includes a list of customers, accounts, or portfolios that have a high adjusted risk score (e.g., so that a manager may more closely monitor those customers). Note that the watch list and/or the adjusted risk scores are generated in accordance with a predicted outlook trend generated by a forecast model for each client's business segment (e.g., based on a series of leading indicator items). The predicted outlook trend may indicate, for example, where the industry is expected to be in terms of growth rates in employment at the end of a forecast horizon. The predicted outlook trend may be, for example, “above” trend (e.g., above an average range and therefore indicating that the industry is in a expansionary phase and/or the high part of a business cycle), at trend (e.g., within an average range associated with normal growth), or “below” trend (e.g., below an average range and there indicating that the industry is contracting and/or the low part of a business cycle).

The watch list display 1300 could also provide other information. For example, the forecast horizon associated with each outlook trend might be displayed (e.g., to indicate how many months out each model forecasts from the last reporting month). A current business segment state might indicate the current employment growth rate for a particular industry sector (e.g., an actual value based on the last reporting month's employment growth). An outlook direction might represent the change in expected employment growth for an industry over the forecast horizon.

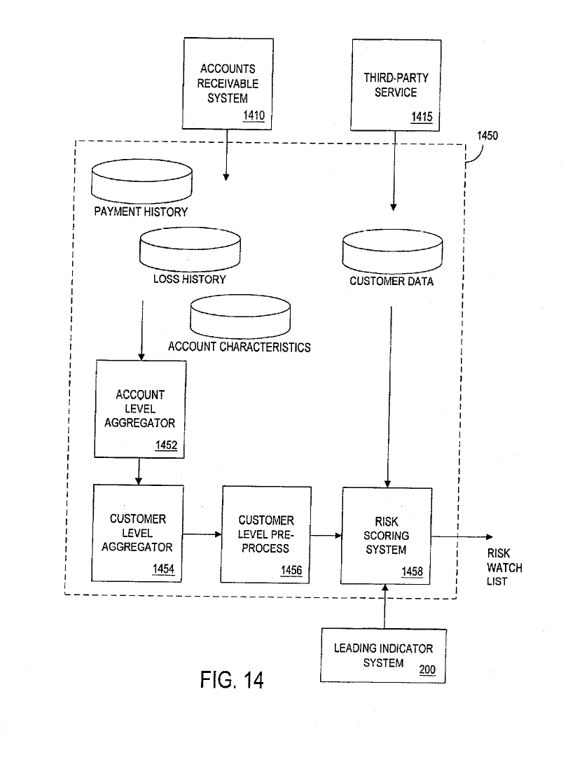

The adjusted risk scores provided on the watch list display 1300 may be generated, for example, by a leading indicator system 200 or a watch list controller. FIG. 14 is a block diagram including elements of a watch list controller 1400 according to some embodiments of the present invention.

Note that a creditor may extend credit to a single customer via a number of separate commercial credit accounts (e.g., one account may be associated with a purchase of trailers while another account is associated with a purchase of machine tools). In this case, the controller 1450 receives information about a number of commercial credit accounts from an accounts receivable system 1410. Based on the received information, a payment history database is updated to indicate whether payments have been made in a timely fashion. Similarly, a loss history database is updated to indicate accounts that have been partially (or entirely) written-off. An account characteristics database is also updated to indicate, for example, the types of collateral that were used to secure commercial credit accounts.

Information from each of these three databases is then provided to an account level aggregator 1452. That is, the account level aggregator 1452 compiles payment, loss, and characteristic information for each commercial credit account. This information is then provided to a customer level aggregator 1454. The customer level aggregator 1454 may, for example, compile information about a number of different accounts associated with a single commercial credit customer. A customer level preprocess 1456 is then performed to format the customer information before the information is provided to a risk scoring system 1458 (e.g., associated with a plurality of risk scoring models).

The risk scoring system 1458 also receives customer data generated by a third-party service 1415. For example, the risk scoring system 1458 may receive information generated by D&B, INC.® The risk scoring system 1458 also receives a predicted business segment outlook from the leading indicator system 200. Based on all of the received information, the risk scoring system 1458 outputs a risk “watch list” indicating high risk customers. A risk manager may then use this information to more closely monitor high risk customers.

Adjusting Potential Credit Deals Based on Forecast Model Predictions

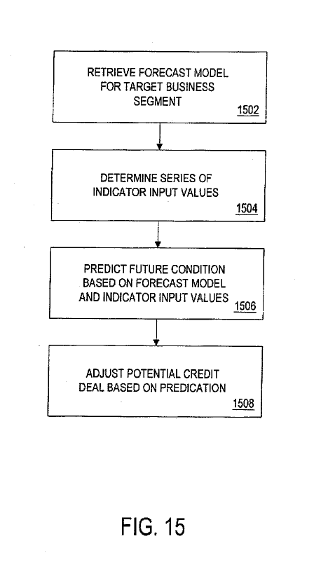

FIG. 15 is a flow chart of a method of facilitating use of targeted indicators according to other embodiments of the present invention. At 1502, a forecast model for a target business segment associated with an existing credit account is retrieved (e.g., from the forecast model database 700). A series of indicator input values is then determined at 1504 (e.g., based on current information stored in the indicator input database 500). A future condition is then predicted based on the series indicator input values and the forecast model at 1506.

At 1508, the potential credit deal is adjusted based on the prediction. For example, the leading indicator system 200 may transmit information to an underwriter device 1230 as illustrated in FIG. 12. An underwriter might then approve or deny a loan based on the predicted outlook for a customer's business segment. The underwriter might otherwise adjust the deal, such as by adjusting a loan amount, a loan spread, and/or a loan duration based on the predicted outlook. Moreover, a term or condition associated with a loan may be adjusted based on the predicted outlook (e.g., a customer may be required to provide a personal guarantee). Note tat the deal may also be associated with a lease (e.g., a lease of commercial equipment). According to still another embodiment, the underwriter device 1230 automatically approves, denies, or otherwise adjusts a potential credit deal.

In this way, the leading indicator system 200 may evaluate the potential impact of macroeconomic and market changes on portfolio performance and profitability. Moreover, a creditor may proactively identify business segments and/or customers that may be at risk and respond in an appropriate manner.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In some of the embodiments described herein, a list is generated to represent the highest risk customers out of all existing commercial credit customers. According to the present invention, however, other types of lists may also be generated. For example, a list of the highest risk customers in a particular geographic region or industry may be generated. Similarly, a list including only newly risky customer may be generated (e.g., customers who were previously identified as high risk would not be included on such a list).

According to still another embodiment, predictions generated by a forecast model are used in connection with a credit decision engine. For example, an active customer may approach a creditor and ask to open a new commercial credit account (e.g., in order to purchase a new truck). The creditor may then use a prediction associated the customer's industry segment to decide whether or not the customer's request will be granted (e.g., a request from a customer having an adjusted risk score of “5” may automatically be declined by a decision engine).

Similarly, predictions generated by a forecast model might be used to determine an amount of credit that can be extended to an active customer. For example, an adjusted risk score associated with a customer may be used to determine that the customer can automatically access a $10,000 line of credit. Note that the actual amount of credit may or may not be disclosed to the customer.

According to still another embodiment, predictions generated by a forecast model are used are used to solicit new business from active customers. For example, additional commercial credit accounts may be offered to all active customers having an adjusted risk score of “1.” The adjusted scoring information may also be used to identify potential customers who do not current have any commercial credit accounts. Other information, such as the likelihood that a potential customer will accept an offer, may also be used to identify or prioritize potential customers.

In another embodiment, predictions generated by a forecast model are used to ensure compliance with credit policy rules and guidelines (e.g., rules established by a chief risk officer). For example, risk managers may be authorized to extend only a pre-determined amount of credit to customers having a threshold adjusted risk score. If the customer is seeking credit over that amount, the controller 1450 may automatically notify the risk manager's supervisor (e.g., a party who is authorized to extend larger amounts of credit).

According to some embodiments of the present invention described herein, one or more forecast models are created and applied repeatedly (e.g., monthly) to generate predictions. According to another embodiment, an adaptive system is provided wherein new forecast models are periodically created or adjusted.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method of facilitating use of targeted indicators, comprising:
determining at least one condition associated with a target business segment;
selecting a series of indicator input items; and
automatically generating a forecast model for the target business segment based on historic information associated with the series of indicator input items and the condition.

2. The method of claim 1, wherein at least one indicator input item include at least one of: (i) economic information, (ii) employment information, (iii) inflation information, (iv) equity information, (v) debt information, (vi) construction information, (vii) backlog information, (viii) new order information, (ix) vacancy information, (x) interest rate information, (xi) money supply information, (xii) payment information, and (xiii) delinquency information.

3. The method of claim 1, wherein said selecting further comprises:
identifying the target business segment;
identifying a series of potential indicator input items; and
evaluating the potential indicator input items.

4. The method of claim 3, wherein said evaluation is associated with at least one of: (i) seasonally adjusted information, (ii) rolling median information, (iii) standardized values, (iv) correlation coefficients, (v) weighted averages, and (vi) graphical analysis.

5. The method of claim 1, wherein the target business segment is associated with at least one of: (i) an industry, (ii) an industry segment, (iii) a market, (iv) a market segment, (v) a customer, and (vi) a group of customers.

6. The method of claim 5, wherein the target business segment is further associated with at least one of: (i) a collateral type, (ii) a geographic location, and (iii) a customer type.

7. The method of claim 5, wherein the target business segment is associated with at least one of: (i) manufacturing, (ii) construction, (iii) retail trade, (iv) services, (v) wholesale trade, (vi) agriculture, (vii) forestry, (viii) fishing, (ix) mining, (x) transportation, (xi) communication, (xii) utility, (xiii) electric, (xiv) gas, (xv) sanitary services, (xvi) finance, (xvii) insurance, (xviii) real estate, and (xix) public administration.

8. The method of claim 1, wherein the condition is associated with at least one of: (i) an economic condition, (ii) a payment information, (iii) a business cycle, and (iv) an industry behavior.

9. The method of claim 1, wherein the condition is associated with a plurality of bins.

10. The method of claim 9, wherein at least one bin is associated with at least one of: (i) an above trend business level, (ii) a trend business level, and (iii) a below trend business level.

11. The method of claim 1, wherein said automatic generation is associated with a linear optimization technique.

12. The method of claim 1, wherein the forecast model is associated with weighing factors applied to each indicator input item.

13. The method of claim 1, wherein the forecast model is associated with at least one of: (i) leading indicator information, (ii) lagging indicator information, and (iii) coincident indicator information.

14. The method of claim 1, further comprising
predicting future conditions based on current indicator input items and the forecast model.

15. The method of claim 14, further comprising:
adjusting a adjusting a score associated with an existing credit account based on said prediction.

16. The method of claim 14, further comprising:
adjusting a potential credit deal based on said prediction.

17. The method of claim 16, wherein said adjusting is associated with at least one of: (i) a loan amount, (ii) a loan spread, (iii) a loan duration, (iv) a loan term, and (v) a lease.

18. The method of claim 14, wherein said predicting is associated with a long term performance forecast in accordance with a time series model.

19. An apparatus, comprising:
a processor; and
a storage device in communication with said processor and storing instructions adapted to be executed by said processor to:
determine at least one condition associated with a target business segment;
select a series of indicator input items; and
automatically generate a forecast model for the target business segment based on historic information associated with the series of indicator input items and the condition.

20. The apparatus of claim 19, wherein said storage device further stores at least one of: (i) a customer database, (ii) an account database, (iii) an indicator input database, (iv) a condition database, (v) a forecast model database, and (vi) a risk information database.

21. The apparatus of claim 19, further comprising:
a communication device coupled to said processor and adapted to communicate with at least one of: (i) a risk manager device, (ii) an underwriter device, (iii) a third party service, (iv) a risk score controller, and (v) a leading indicator system.

22. A medium storing instructions adapted to be executed by a processor to perform a method of facilitating use of targeted indicators, said method comprising:
determining at least one condition associated with a target business segment;
selecting a series of indicator input items; and
automatically generating a forecast model for the target business segment based on historic information associated with the series of indicator input items and the condition.

23. A method of facilitating use of targeted indicators, comprising:
retrieving a forecast model for a target business segment associated with an existing credit account;
determining a series of indicator input values;
predicting a future condition based on the forecast model and the series of indicator input values; and
adjusting a score associated with the credit account based on said prediction.

24. A method of facilitating use of targeted indicators, comprising:
retrieving a forecast model for a target business segment associated with a potential credit deal;
determining a series of indicator input values;
predicting a future condition based on the forecast model and the series of indicator input values; and
adjusting the potential credit deal based on said prediction.

25. The method of claim 24, wherein said adjusting is associated with at least one of: (i) a loan amount, (ii) a loan spread, (iii) a loan duration, (iv) a loan term, and (v) a lease.
